(19) United States
(12) Patent Application Publication
(10) Pub. No.: US 2006/0050983 A1
(43) Pub. Date: Mar. 9, 2006

(54) Method and apparatus for enhancing the contrast and clarity of an image captured by a remote viewing device

(75) Inventors: Clark A. Bendall, Syracuse, NY (US); Steven C. Crews, Newnan, GA (US)

Correspondence Address: WALL MARJAMA & BILINSKI, 101 SOUTH SALINA STREET, SUITE 400, SYRACUSE, NY, 13202, US

(73) Assignee: Everest VIT, Inc., Skaneateles Falls, NY (US)

(21) Appl. No.: 10/936,373

(22) Filed: Sep. 8, 2004

(51) Int. Cl. G06K 9/40

(52) U.S. Cl. 382/274

(57) ABSTRACT

A method and apparatus for enhancing the contrast and visual clarity of an image captured by a remote viewing device. A luminance component of a captured image is isolated and represented within a first distribution of luminance values. One or more transformation functions are performed upon the first distribution of luminance values to generate a second distribution of luminance values. The second distribution of luminance values are used to construct and display a second image having enhanced visual clarity relative to the captured image. A portion of the captured image, such as a portion functioning as a magnified zoom window, can be enhanced for visual clarity independently from the remaining portion of the captured image.

### FIELD OF THE INVENTION

This invention relates generally to a method and apparatus for enhancing the contrast and visual clarity of a captured image, and specifically relates to enhancing the visual clarity of an image captured by a remote viewing device.

### BACKGROUND OF THE INVENTION

A remote viewing device, such as an endoscope or a borescope, often is characterized as having an elongated and flexible insertion tube with a viewing head at its forward (distal) end, and a control section at its rear (proximal) end. An endoscope is generally used for remotely inspecting the interior portions of a body cavity for the purpose medical diagnosis or treatment. A borescope is generally used for inspection of interior portions of industrial equipment. An industrial video endoscope has articulation cabling and image capture components used to inspect industrial equipment.

Image information is communicated through the insertion tube from the viewing head to the control section. The image information is displayed onto a video screen for viewing by an operator. Typically, an insertion tube is 5 to 100 feet in length and approximately ⅙ to ½″ in diameter. Tubes of other lengths and diameters are possible depending upon the application of the remote viewing device.

Images that are captured by remote viewing devices are typically captured from within remotely located spaces having limited volume and little or no ambient light. Remote control of the viewing head provides limited control of the proximity and the angle of view of the viewing head relative to a particular target. Consequently, images that are captured by remote viewing devices are often of less-than-optimal visual clarity. Remote viewing devices are generally used to inspect for defects such as cracks, dents, corrosion etc. These defects are often subtle and not easily visible to the inspector.

### SUMMARY OF THE INVENTION

The present invention provides methods and a plurality of apparatus for enhancing the visual clarity of an image captured by a remote viewing device. In some embodiments, a first original image is captured and a luminance component associated with each of the pixels of the captured first original image is quantified and represented within a first distribution of luminance values. One or more transformation functions are performed upon the first distribution of luminance values to generate a second distribution of luminance values. The second distribution of luminance values is used to construct and display a second image providing enhanced visual clarity relative to that of the captured first original image.

In some embodiments, a portion of the captured image, such as a portion functioning as a magnified zoom window, is enhanced for visual clarity using one or more transformation functions that are applied independently of transformation functions, if any, applied to the remaining portion of the captured image. In other embodiments, the same transformations are applied to the zoom window as well as the captured image. In yet other embodiments, the entire captured image is enhanced with or without the presence of a zoom window.

Optionally, different and more extreme luminance expansion is provided within a portion of an original image as compared to the luminance expansion provided for the entire original image. In this embodiment, the portion of an original image has a narrower range of luminance than the range of luminance of the entire original image. The partial image can be un-magnified or magnified (zoom window) relative to the original image.

Transformation functions include a luminance inversion function, a luminance expansion function, a luminance shifting function and a luminance dividing function and a luminance shifting and dividing function. Portions of a luminance distribution can be shifted towards or away from each other.

In some embodiments, both un-transformed and transformed portions of an original image are displayed and/or optionally magnified. Quantifying, mapping (transforming) and displaying steps are performed on at least one original image to generate a transformed image. Optionally, the original and transformed images are displayed simultaneously.

Optionally, separate and different mapping steps or the same mapping steps are performed to generate said first transformed image and said second transformed image. Optionally, at least a portion of both said first transformed image and said second transformed image are displayed simultaneously.

In some embodiments, an original image is represented by an RGB color space model that is translated into a different color space model prior to the luminance transformation. Optionally, transformation can be performed using a quasi-luminance transformation function.

In one embodiment, an apparatus for enhancing the clarity of at least a portion of an image captured by a remote viewing device includes a luminance isolator and a luminance transformer.

The luminance isolator that is configured for processing a first original image captured by a remote viewing device, the first original image represented by a plurality of pixels and where each of said plurality of pixels has an original luminance component; and configured for selecting a second plurality of pixels, said second plurality of pixels constituting a second original image and including at least a subset of said plurality of pixels of said first original image; and configured for quantifying each said original luminance component as an original luminance value for each of said second plurality of pixels to collectively form a second plurality of original luminance values that are represented within a second original distribution of said original luminance values, said second original distribution of said original luminance values representing a second original image.

The luminance transformer is configured for mapping each said original luminance value represented within said second original distribution of luminance values to an associated transformed luminance value represented within a second transformed distribution of luminance values, said second transformed distribution of luminance values representing a second transformed image.

In another embodiment, a remote viewing device includes an insertion tube, a viewing head assembly disposed at a distal end of the insertion tube that is configured for capturing an image, a luminance isolator and a luminance transformer.

The luminance isolator is configured for processing a first original image captured by said viewing head, the first original image represented by a plurality of pixels and where each of said plurality of pixels has an original luminance component, and selecting a second plurality of pixels, said second plurality of pixels constituting a second original image and including at least a subset of said plurality of pixels of said first original image, and quantifying each said original luminance component as a original luminance value for each of said second plurality of pixels, to collectively form a second plurality of original luminance values that are represented within a second original distribution of said original luminance values.

The luminance transformer is configured for mapping each said original luminance value represented within said second original distribution of luminance values to an associated transformed luminance value represented within a second transformed distribution of luminance values, said second transformed distribution of luminance values representing a second transformed image.

### BRIEF DESCRIPTION OF THE DRAWINGS

For a further understanding of these and objects of the invention, reference will be made to the following detailed description of the invention which is to be read in connection with the accompanying drawing, wherein:

FIG. 1A illustrates a first original image 110 including a marked area 112 with an oblong shaped perimeter and a partial original image 130a including a portion of the marked area.

FIG. 1B illustrates the first original image 110 of FIG. 1 and a superimposed and magnified second image 130b that is a magnification of the partial original image 130a of FIG. 1A.

FIG. 1C illustrates the first original image 11 of FIG. 1 and a superimposed second image 130c. The superimposed second image 130c is transformed from the magnified second image 130b of FIG. 2 via a luminance inversion function.

FIG. 2 illustrates an embodiment of a remote viewing device 10 that includes a viewing head assembly 14 incorporating an image sensor (not shown), an insertion tube 12, a hand control unit 16, an umbilical chord 26, a light box 34 and a display monitor 40 for viewing images captured via the image sensor (not shown).

FIG. 3A is a block diagram illustrating exemplary image processing components of the remote viewing device 10.

FIG. 3B is a block diagram illustrating exemplary image acquisition circuitry for the image processing circuit 230.

FIG. 4 illustrates a first original image 410 including two areas 412a, 412b that are each marked by an oblong shaped perimeter, a partial first original image 430a and a magnified second original image 430b.

FIG. 5, the preferred embodiment of the invention, illustrates a first transformed image 510, including two areas 512a, 512b that are each marked by an oblong shaped perimeter, a partial first transformed image 530a and a magnified second transformed image 530.

FIG. 6 illustrates a first transformed image 610, including two areas 612a, 612b that are each marked by an oblong shaped perimeter, a partial first transformed image 630a and a magnified second transformed image 630.

FIG. 7 illustrates a first distribution of pixel luminance values of an image that range between a minimum luminance value of 60 and a maximum luminance value of 140.

FIG. 8A illustrates a second distribution of pixel luminance values that is transformed from the first distribution of pixel luminance values of FIG. 7 via a luminance uniform expansion function.

FIG. 8B illustrates a second distribution of pixel luminance values that is transformed from the first distribution of pixel luminance values of FIG. 7 via luminance non-uniform expansion function.

FIG. 8C illustrates a second distribution of pixel luminance values that is transformed from the first distribution of pixel luminance values of FIG. 7 via a luminance consolidation and flattening function.

FIG. 8D illustrates a second distribution of pixel luminance values that is transformed from the first distribution of pixel luminance values of FIG. 7 via a combination of a luminance flat consolidation function and a luminance uniform expansion function.

FIG. 9 illustrates a third distribution of pixel luminance values of an image that range between a minimum luminance value of 10 and a maximum luminance value of 70.

FIG. 10 illustrates a fourth distribution of pixel luminance values which is transformed from the third distribution of pixel luminance values of FIG. 9 via a luminance inversion function.

FIG. 11 illustrates a fifth distribution of pixel luminance values which is transformed from a distribution of pixel luminance values of FIG. 9 via a luminance shifting function.

FIG. 12 illustrates a sixth distribution of pixel luminance values which is transformed from the fifth distribution of pixel luminance values of FIG. 11 via a luminance separating and shifting function.

FIG. 13 illustrates two halves of a stereo image 1310a, 1310b including a marked area 1312 with an oblong shaped perimeter, a first and second partial images 1330a, 1340a that each include a portion of the marked area 1312 and first and second superimposed partial images 1330a and 1330b that are each a magnification of the partial images 1330a and 1330b respectively.

### DETAILED DESCRIPTION OF THE INVENTION

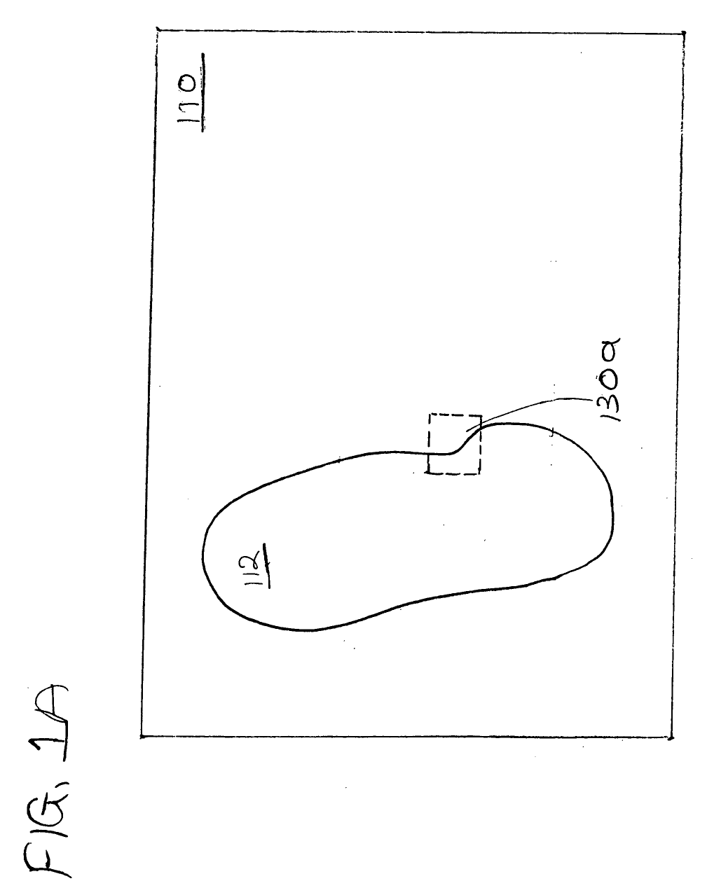

FIG. 1A illustrates a first original image 110 including a marked area 112 with an oblong shaped perimeter and a partial original image 130a including a portion of the marked area 112. The first original image 110 is digital image including a plurality of pixels. The marked area 112 located within the first original image 110 represents a surface area having one or more cracks, and/or one or more dents and/or corrosion. The partial original image 130a represents an area within the first original image 110 of particular interest.

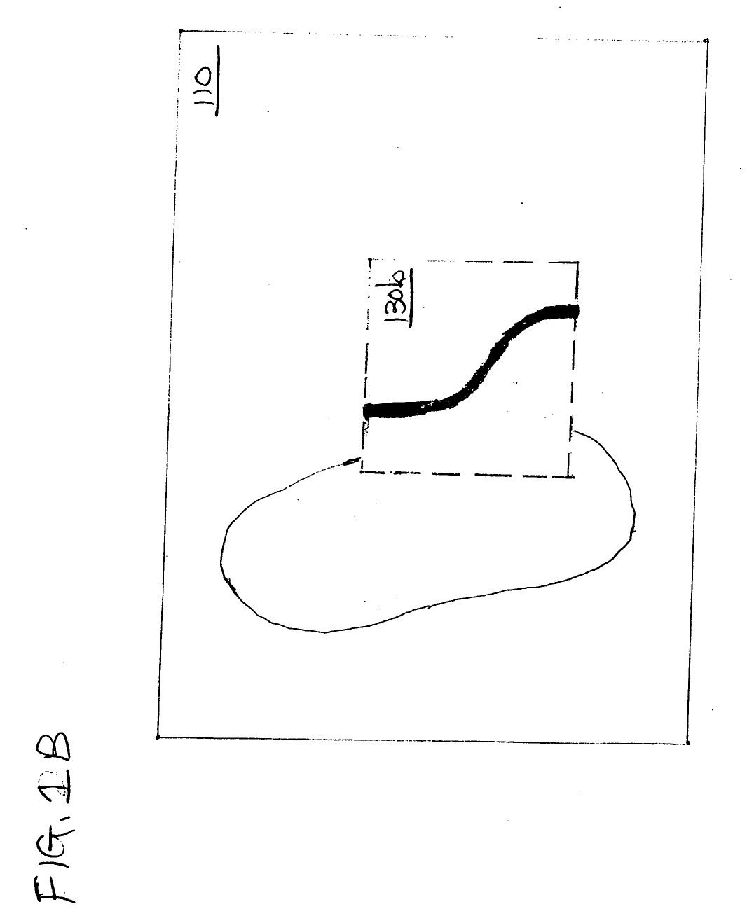

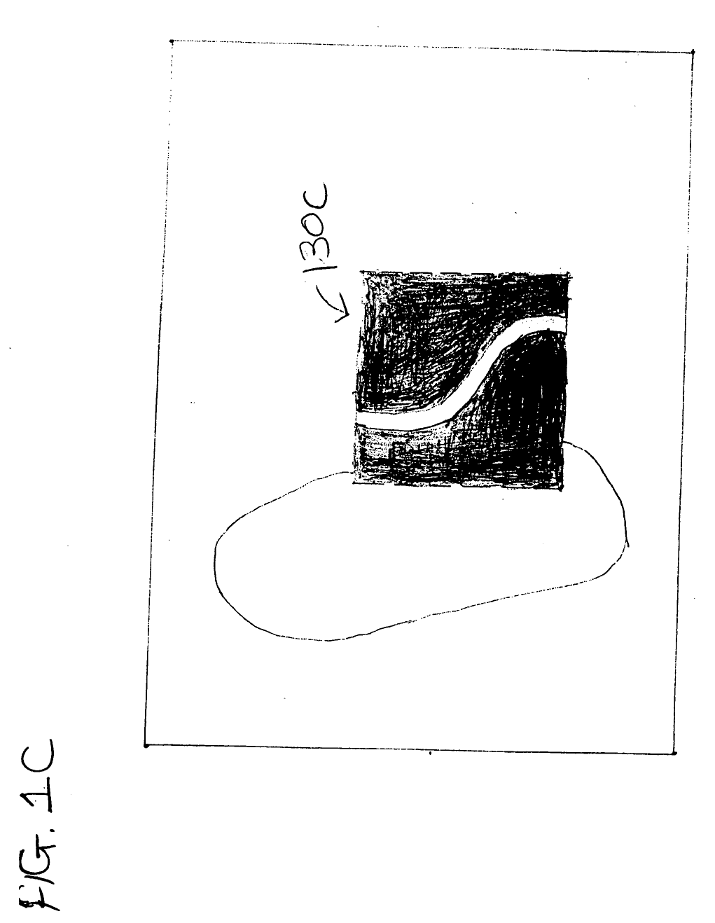

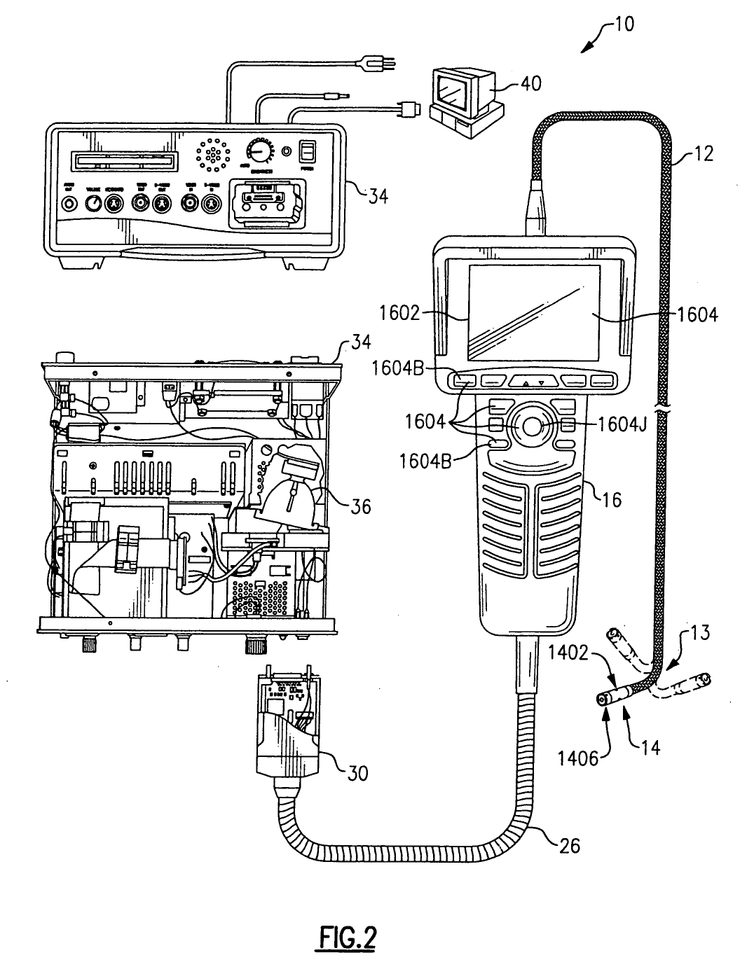

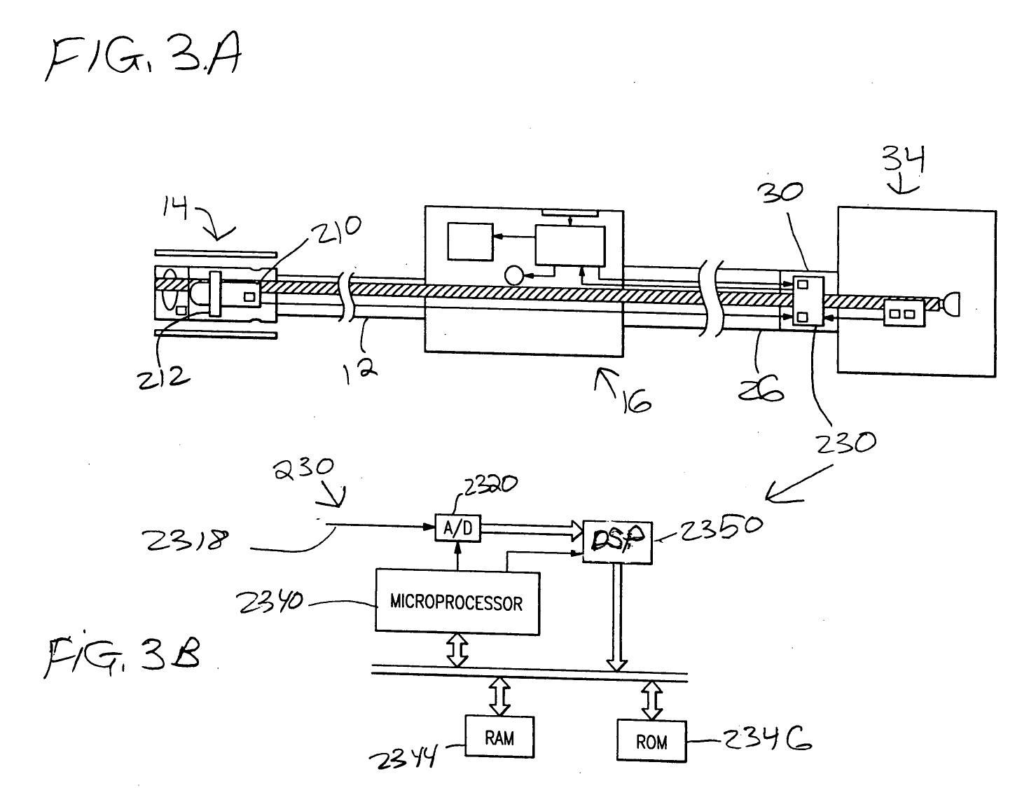

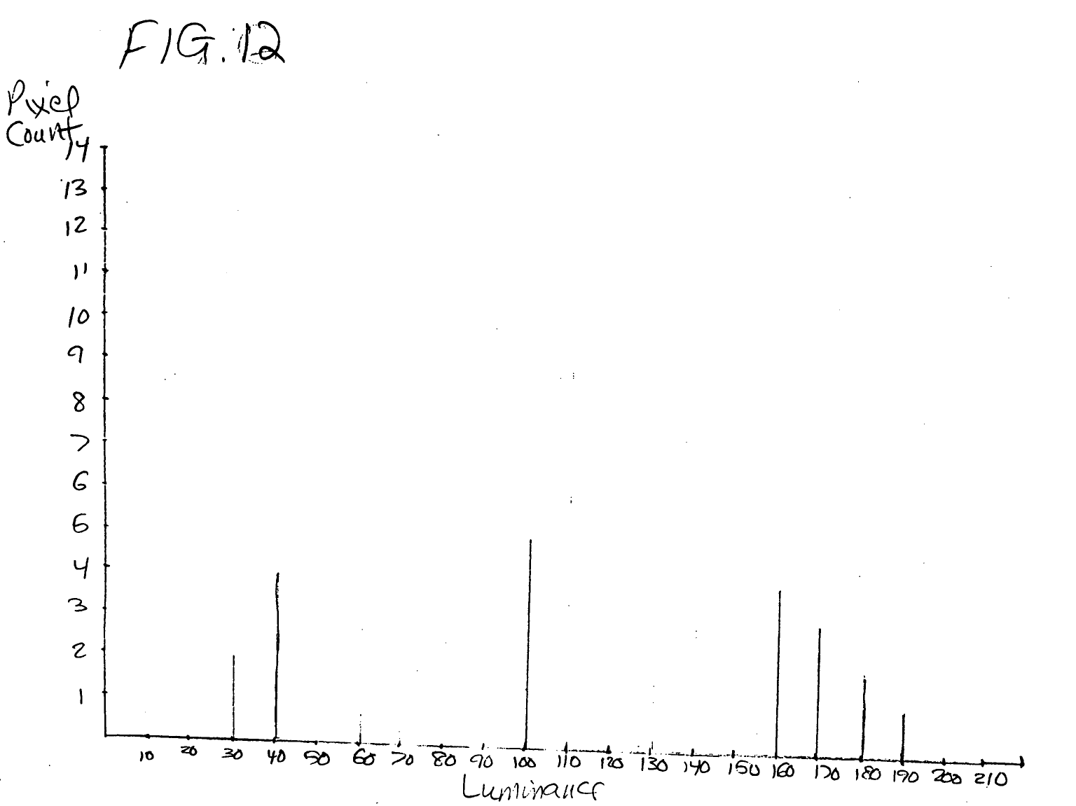

FIG. 11B illustrates the first original image 110 of FIG. 1 and a superimposed second image 130b that is a magnification of the partial original image 130a of FIG. 1. As shown, the second image 130b is scaled to approximately 4 times the size of the partial original image 130a of FIG. 1. The second image 130b has the same luminance distribution characteristics as that of the partial original image 130a of FIG. 1. No luminance transformation has been yet performed within FIGS. 1 and 2.

FIG. 1C illustrates the first original image 110 of FIG. 1 and a superimposed second image 130c. The superimposed second image 130c is transformed from the magnified second image 130b of FIG. 2 via a luminance inversion function. A luminance inversion function modifies (maps) the original luminance value of individual pixels to a transformed luminance value in order to invert the illumination of each pixel.

Luminance is a measure of brightness as seen through the human eye. In one grayscale embodiment, luminance is represented by an 8 bit (1 byte) data value encoding decimal values 0 through 255. Typically, a data value equal to 0 represents black and a data value equal to 255 represents white. Shades of gray are represented by values 1 through 254.

Alternatively, a 0 through 200 (decimal) range will be used to represent luminance values for individual pixels for the purpose of describing various embodiments of the invention. A minimum luminance value (black pixel) is equal to 0 units and a maximum luminance value (white pixel) is equal to 200 units.

The invention applies to any representation of an image for which luminance can be quantified directly or indirectly via a translation to another representation. For example, with respect to embodiments that process a color image, the color space models that directly quantify the luminance component of image pixels, including but not limited to those referred to as the YUV, YCbCr, YPbPR, YCC and YIQ color space models, can be used to directly quantify the luminance (Y) component of each (color) pixel of an image as a pre-requisite to luminance transformation of the image.

Also, color space models that do not directly quantify the luminance of image pixels, including but not limited to those referred to as the red-green-blue (RGB), red-green-blue-alpha (RGBA), hue-saturation-(intensity) value (HSV), hue-lightness-saturation (HLS) and the cyan-magenta-yellow-black (CMYB) color space models, can be used to indirectly quantify (determine) the luminance component of each (color) pixel.

In these types of embodiments, a color space model that does not directly quantify the luminance component of image pixels, such as the RGB color space model for example, can be translated into a color space model, such as the YCbCr color space model for example, that directly quantifies the luminance component of image pixels. This type of translation can be performed as a pre-requisite to performing one or more luminance transformation functions upon the YCbCr translated image. For example, the luminance transformation functions can include one or more embodiments of luminance inversion, luminance expansion or luminance shifting types of functions. Following luminance transformation, the YCbCr translated image is optionally translated back into its original (RGB) color space model for display or directly displayed from the YCbCr color space.

In alternative embodiments, quasi-luminance transformation functions as opposed to direct luminance transformation functions, can be performed upon an original image. For example, RGB color information representing an original image can be inverted without performing any direct transformation of the luminance component of the original image. Because there is a correlation between image color and luminance, RGB color inversion is a quasi-luminance transformation function that indirectly performs an inexact type of luminance inversion upon the original image.

A potential disadvantage of this type of approach is that RGB inversion can cause a substantial color shift to the RGB inverted image. To demonstrate such a color shift, an RGB inversion operation can be performed on an RGB represented image using an imaging software product, such as the Viewprint product. Depending upon the particular application of this type of embodiment, this may or may not constitute a disadvantage relative to embodiments that perform direct luminance transformation of an original image.

Other embodiments of quasi-luminance transformation of an image include transformation of image attributes other than luminance. For example, such attributes can include various measures of brightness, intensity, chrominance and saturation of the image that when transformed, indirectly perform some form of luminance transformation.

A luminance inversion function maps (inverts) an original luminance value of a pixel to a transformed luminance value. The transformed luminance value of a pixel is equal to the maximum luminance value (200) minus the original luminance value of the pixel.

For example, if a pixel has an original luminance value of 30 units, a luminance inversion function maps this value to a value of 170 units (maximum luminance value (200)−original luminance value (30). An original luminance value of 0 units is mapped to a luminance value of 200 units and an original luminance value of 200 units is mapped to a luminance value of 0 units. An original luminance value of 100 units is mapped to a luminance value of 100 units, remaining unchanged. In other words, the darkest pixels are transformed to the lightest pixels, moderately dark pixels are transformed to moderately light pixels, etc.

FIG. 2 illustrates an embodiment of a remote viewing device 10 that includes a viewing head assembly 14 incorporating an image sensor (See FIG. 3A), an insertion tube 12, a hand control unit 16, an umbilical chord 26, power plug 30, a light box 34 and a display monitor 40 for viewing images captured via an image sensor. The viewing head assembly 14 includes a viewing head 1402 including an image sensor and an optical tip 1406.

Illustrative embodiments of a remote viewing device are described in U.S. non-provisional patent application Ser. No. 10/768,761, titled “Remote Video Inspection System”, filed Jan. 29, 2004 and which is hereby incorporated by reference in its entirety.

The remote viewing device 10 includes a hand piece display 1602 which is implemented as an LCD monitor providing a visual user interface 1604. A set of controls 1604 include multiple control buttons 1604B and a joystick 1604J. A light source 36 such as a 50-watt metal halide arc lamp is disposed within the light box 34.

The viewing head assembly 14 and the image sensor are located at a distal end 13 of the insertion tube 12. In use, the distal end 13 of the insertion tube 12 is placed into remotely located spaces, such as spaces that are located inside of industrial equipment, to obtain image information that would be otherwise more difficult and/or costly to obtain directly with the human eye.

FIG. 3A is a block diagram illustrating exemplary image processing components of the remote viewing device 10 that include a viewing head assembly 14 and an image processing circuit 230. The viewing head assembly 14 includes an image signal conditioning circuit 210 and an image sensor 212. The image processing circuit 230 resides within the power plug 30 that is disposed adjacent to the light box 34.

The image signal conditioning circuit 210 receives image signal clocking and control signals from the image processing circuit 230 for control of the image sensor 212, and conditions analog image signals generated by image sensor 212 for delivery to the image processing circuit 230.

FIG. 3B is a block diagram illustrating exemplary image acquisition circuitry of the image processing circuit 230. A real time video signal is communicated from image signal conditioning circuit 210 of the viewing head 14, propagates along line 2318 and is input into an analog-to-digital converter 2320.

Digital signals output from the analog-to-digital converter 2320 are input into a digital signal processor (DSP) 2350, which processes and transfers image data buffered by DSP 2350 to random access memory (RAM) 2344. In other embodiments, a field programmable gate array (FPGA) can be employed to perform the functions of the digital signal processor (DSP). The RAM 2344 stores eight bit gray scale pixel data representing a stored image. The operations of analog-to-digital converter 2320 and DSP 2350 are managed by a microprocessor 2340. In other embodiments, operations of analog-to-digital converter 2320 and DSP 2350 are managed by a timing generator. The DSP and the microprocessor 2340 operate under the control of parameters and a program (digital logic) stored in ROM 2346.

The program (digital logic) controls the microprocessor 2340 to process image data stored as pixels within the RAM. Image data is processed in part, by selecting, quantifying and transforming the luminance characteristics of images incoming from the image sensor 230 and stored into RAM 2346. Processed image data is output via the display monitor 40.

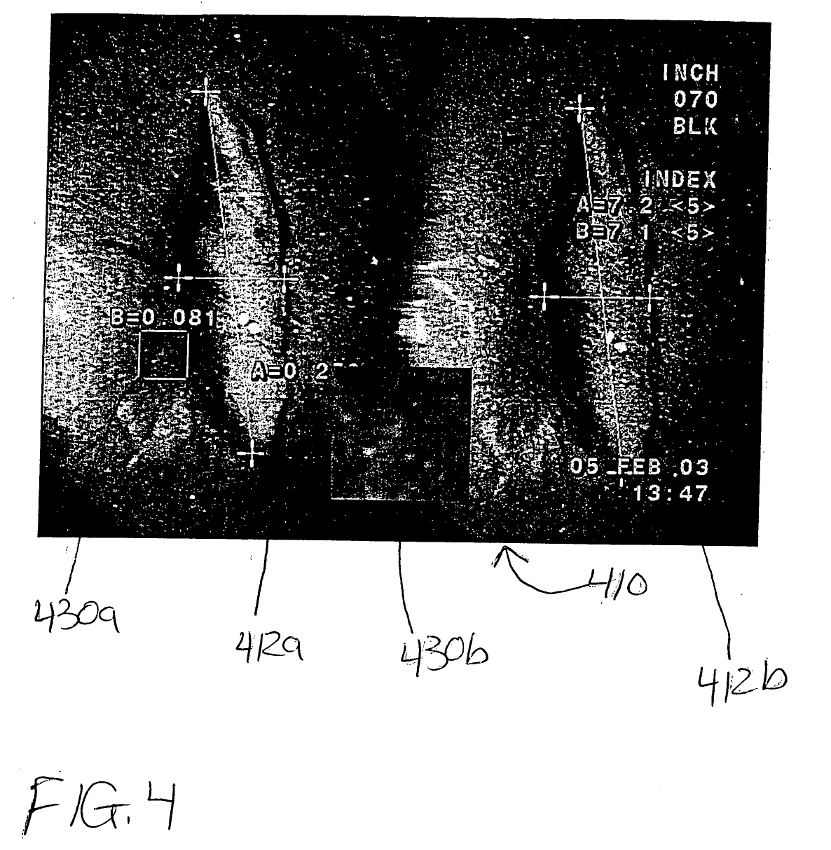

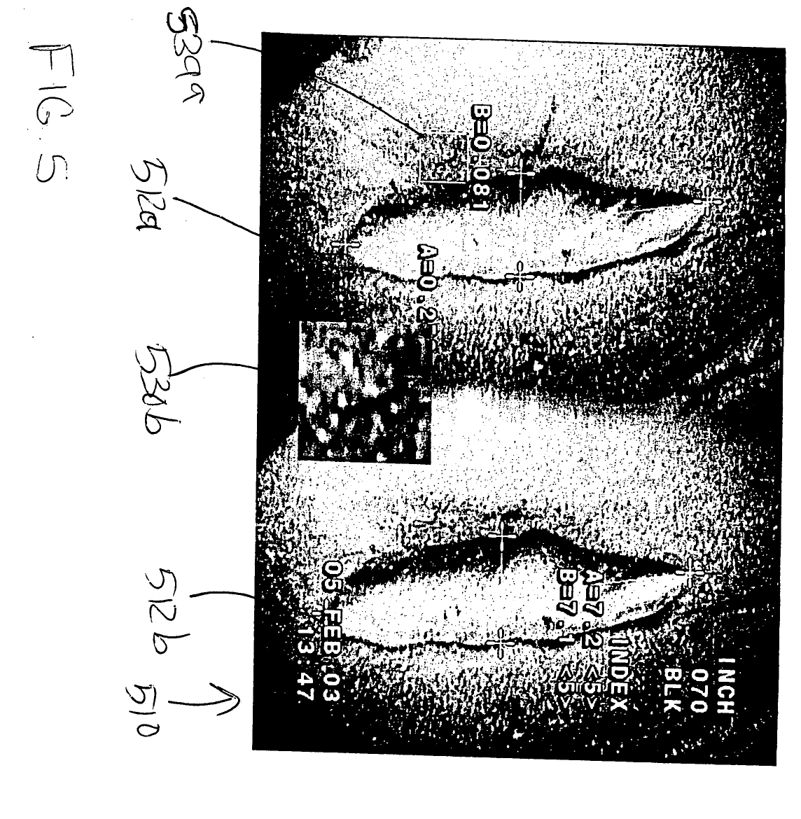

FIG. 4 illustrates a first original image 410 including two areas 412a, 412b that are each marked by an oblong shaped perimeter, a partial first original image 430a and a magnified second original image 430b. The second original image 430b that is a magnification of the partial first original image 430a and is superimposed upon the first original image 410.

The marked areas 412a, 412b are shown in stereo and represent a surface area of interest that can include one or more cracks, and/or one or more dents and/or corrosion. The partial original image 430a represents an area within the first original image 110 of particular interest. As shown, the magnified second original image 430b is scaled to approximately 3 times the size of the partial first original image 430a. The magnified second original image 430b has the same luminance distribution characteristics as that of the partial first original image 430a. No luminance transformation has been performed within FIG. 4.

FIG. 5, the preferred embodiment of the invention, illustrates a first transformed image 510, including two areas 512a, 512b that are each marked by an oblong shaped perimeter, a partial first transformed image 530a and a magnified second transformed image 530. The magnified second transformed image 530 is a magnification of the partial first transformed image 530a and is superimposed upon the first transformed image 510. The first transformed image 510 is transformed from the first original image 410 of FIG. 4 via a luminance expansion function.

As shown, the first transformed image 510 provides an image with enhanced contrast and clarity as compared that provided by the first original image 410 of FIG. 4. For example, the first transformed image 510 provides more clearly visible oblong shaped perimeters defining the areas 512a, 512b as compared to the oblong shaped perimeters defining the areas 412a, 412b of the first original image 410 of FIG. 4.

Image luminance along the outside and the inside of the right side of the perimeter is substantially light while the perimeter itself is substantially dark. Image luminance along the outside of the left side of the perimeter is a mixture of dark and light spots while along the inside of the left side of the perimeter is substantially dark.

A luminance expansion function maps (modifies) an original luminance value to a transformed luminance value for each pixel within an image in order to expand the range of (spread) the distribution of luminance values of pixels within the image. This technique increases the differences in the amount of luminance between pixels originally having different luminance values. Consequently, pixels with different luminance values are more distinguishable, especially when they are located proximate to each other. The luminance expansion function decreases and opposes uniform illumination of an image.

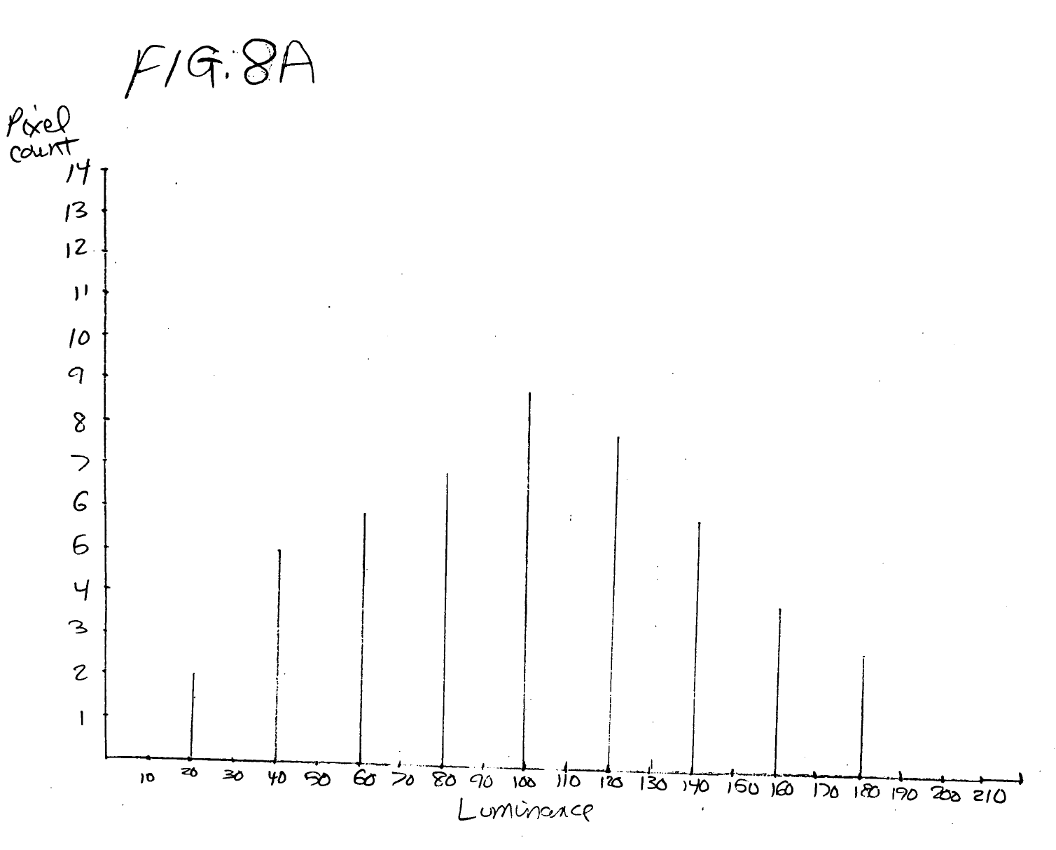

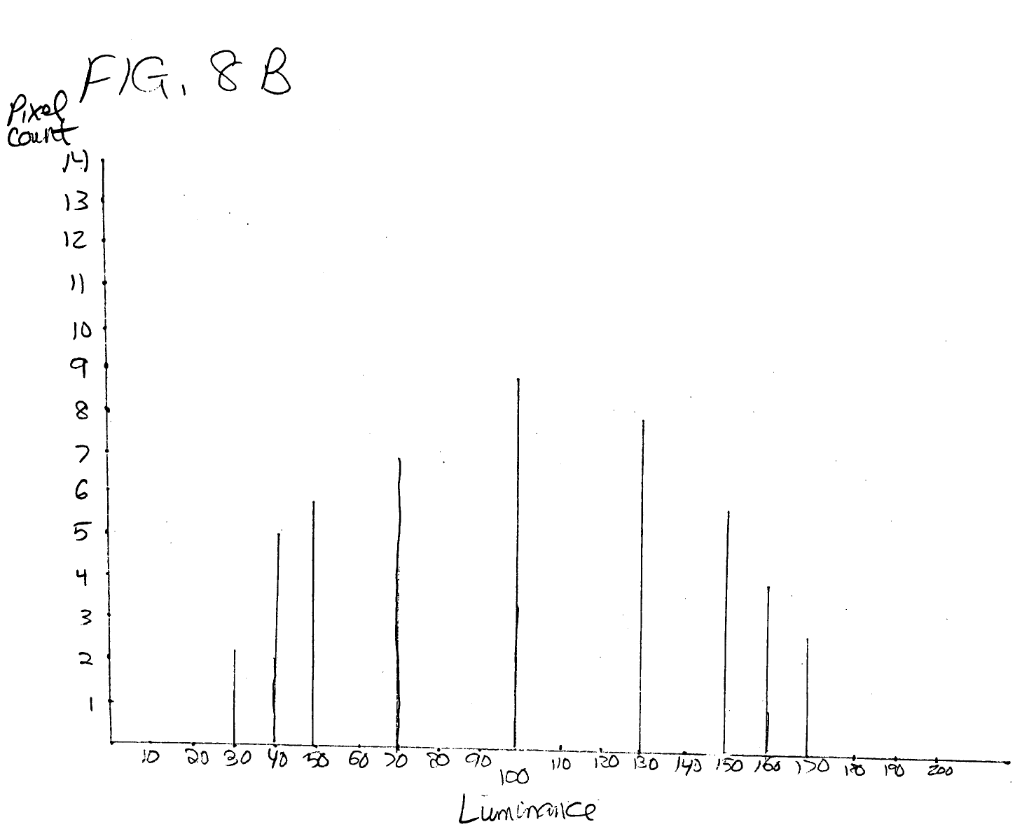

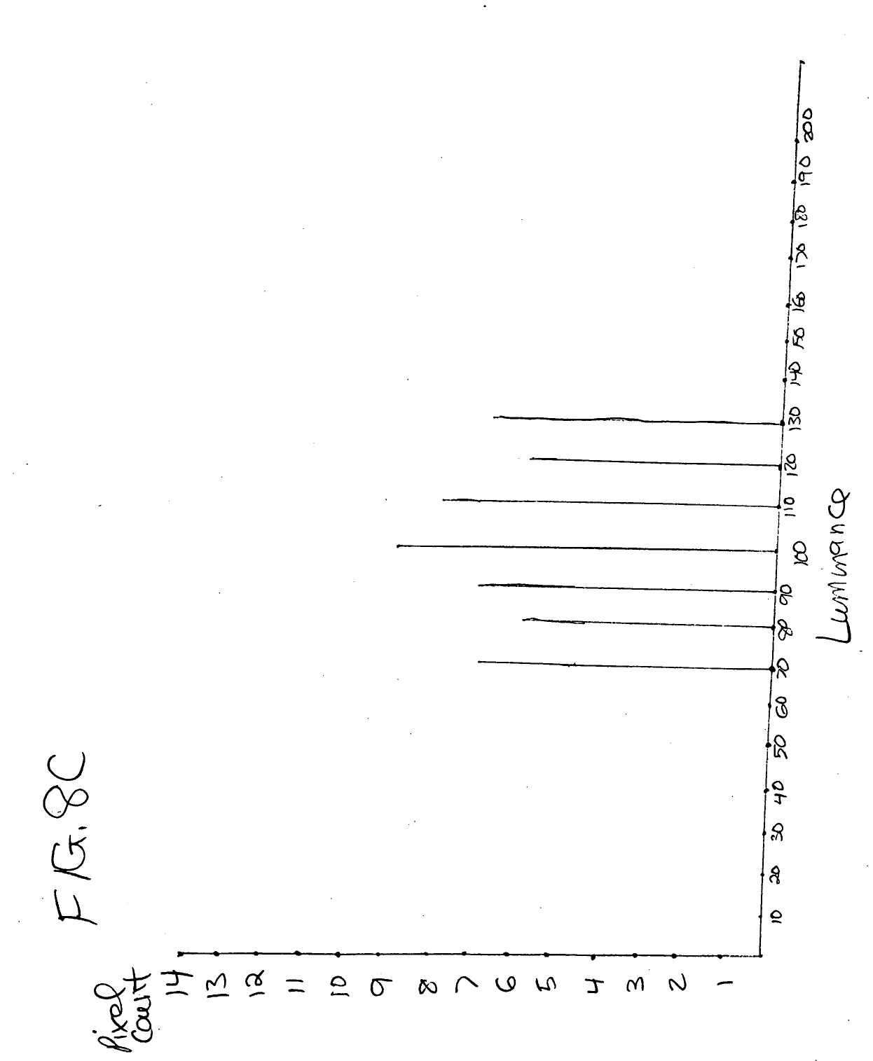

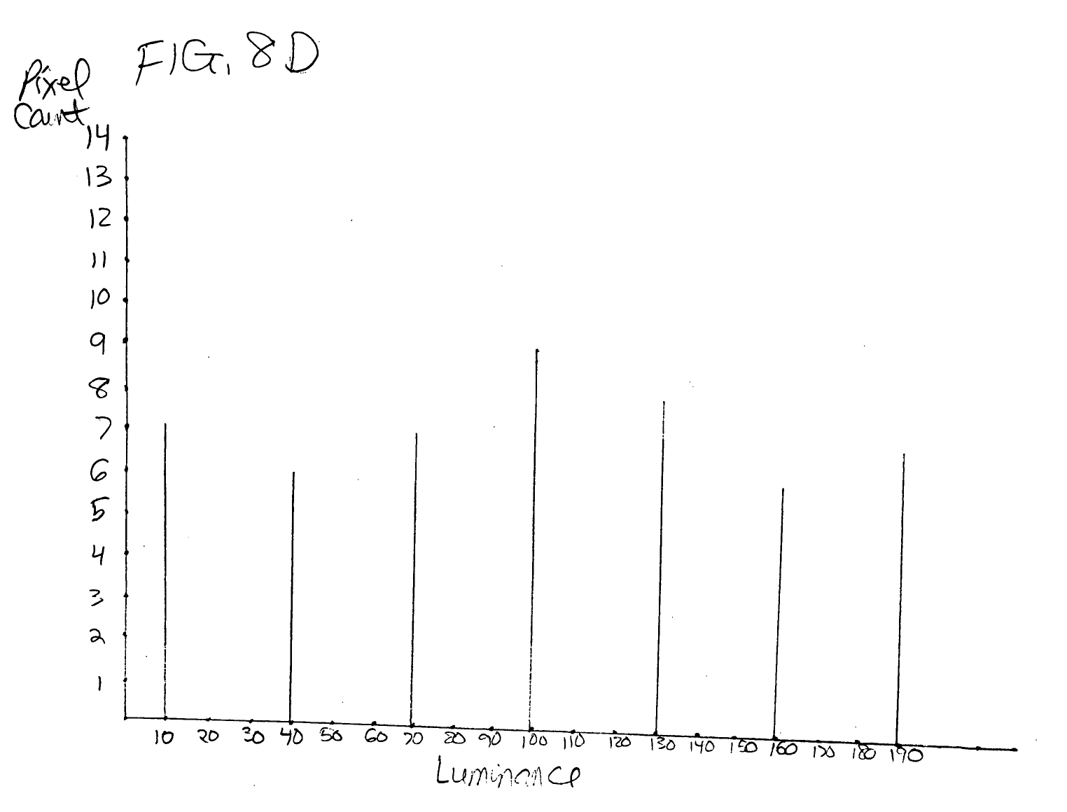

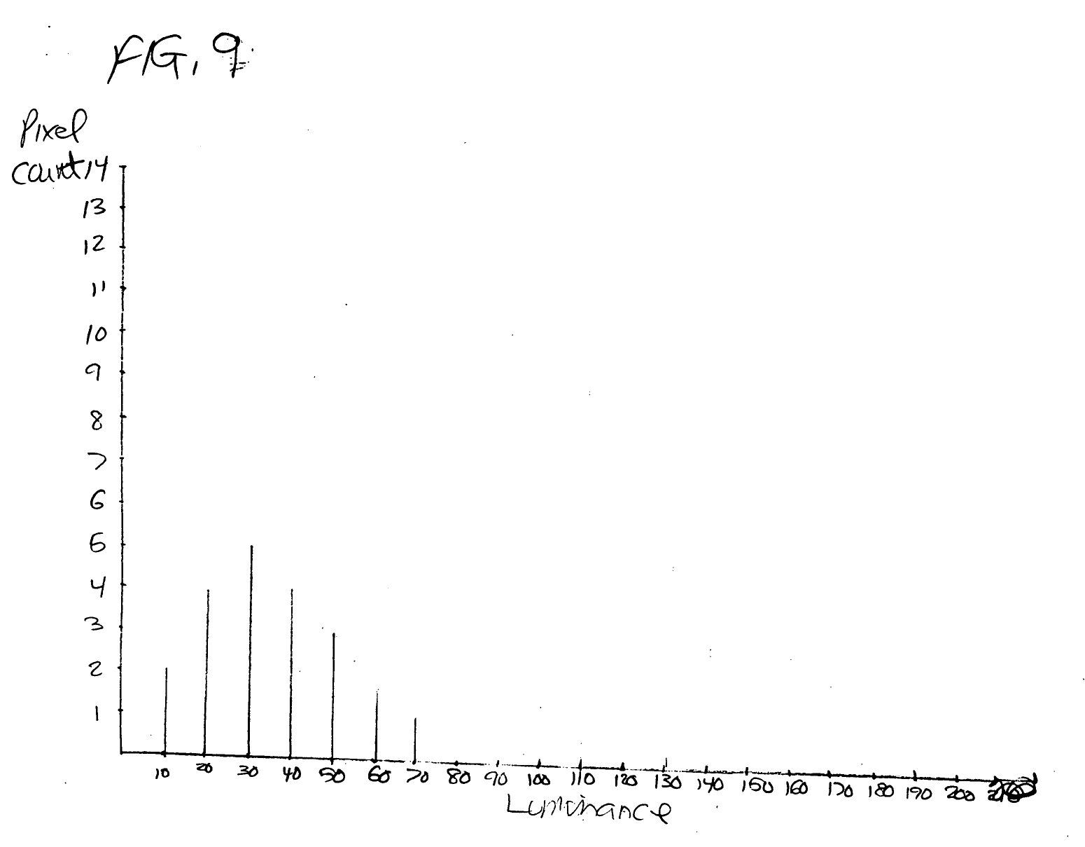

The luminance expansion function, further described in FIGS. 7 and 8, transforms the mathematical distribution of luminance values of pixels residing within an image. As shown in FIG. 7, groups of pixels have luminance values of either 60, 70, 80, 90, 100, 110, 120, 130 or 140 units. The difference in luminance between pixels having different original luminance values is at least 10 units or a multiple of 10 units.

As shown in FIG. 8A, a second distribution of pixel luminance values is transformed from the first distribution of pixel luminance values of FIG. 7 via a luminance uniform expansion function. As shown, groups of pixels have luminance values of 20, 40, 60, 80, 100, 120, 140, 160 or 180 units. The difference in luminance between pixels having different original luminance values is at least 20 units or a multiple of 20 units. As shown, this technique increases the differences in the amount of luminance between pixels originally having different luminance values.

Referring to FIG. 5, luminance expansion is applied to the first original distribution of luminance values of the image 410 of FIG. 4 to create the first transformed distribution of luminance values used to construct image 510. Optionally, a second original distribution of luminance values is created from the luminance values of the pixels included within the partial image 430a.

The (partial) second original distribution likely contains a smaller (narrower) range of luminance values than that of the (full) first original distribution because the (partial) second original distribution typically includes a relatively small subset of the pixels of the (full) first original distribution.

Luminance expansion applied separately to the (partial) second original distribution likely achieves greater enhancement of contrast and clarity than can be achieved when luminance expansion is performed on the (full) first original distribution. This is true because, within the same minimum and maximum luminance boundaries, a narrower original distribution can be expanded by a larger percentage (proportion) than that of a wider original distribution. This approach likely results in more enhanced contrast and clarity within the (partial) second transformed image 530b than that of the (full) first transformed image 510.

For example, if the (full) first original distribution has a range of luminance between a minimum luminance of 20 units and a maximum luminance of 180 units, then the luminance of the (full) first original distribution can be expanded a total of 40 units ((20 units−0 units)+(200 units−180 units)) within the limits of the (0 units−200 unit) luminance scale. Given that the range of the (full) first original distribution is 160 units (180 unit−20 units), a luminance expansion of 40 units allows for 25% (40 units/160 units) of luminance expansion available to the (full) first original distribution.

Alternatively, if the (partial) second original distribution has a range of luminance between a minimum luminance of 60 units and a maximum luminance of 140 units, then the luminance of the (partial) second original distribution can be expanded a total of 120 units ((60 units−0 units)+(200 units−140 units)) within the limits of the (0 units−200 unit) luminance scale. Given that the range of the (partial) second original distribution is 80 units (140 units−60 units), a luminance expansion of 120 units allows for 150% (120 units/80 units) of luminance expansion available to the (full) first original distribution. This type of circumstance is preferably exploited by providing proportionately more luminance expansion within a (partial) second transformed distribution than can be provided for the (full) first transformed distribution.

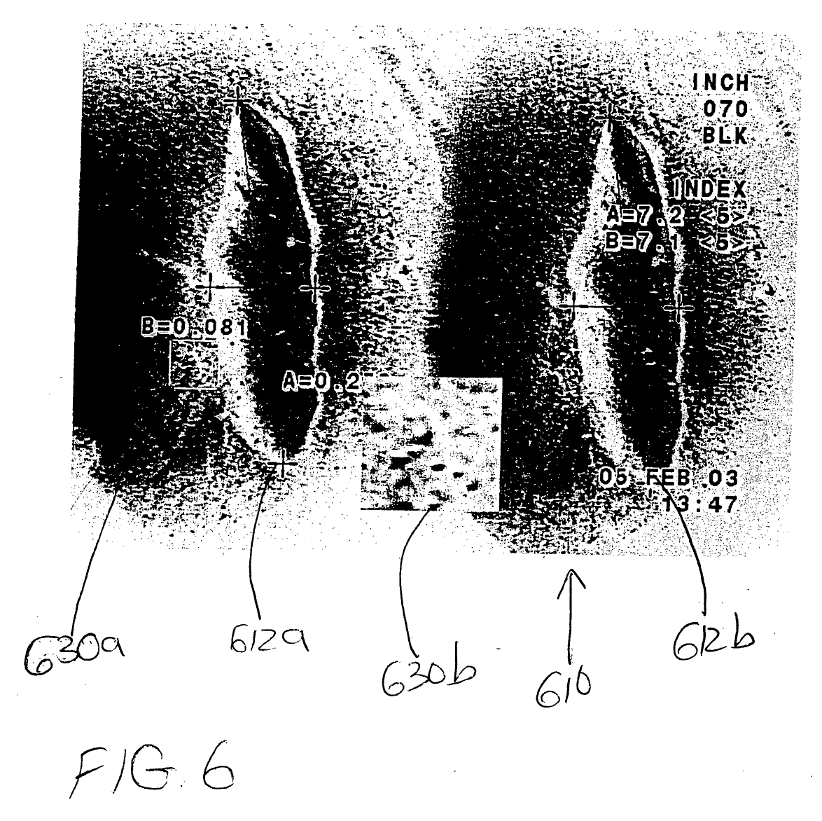

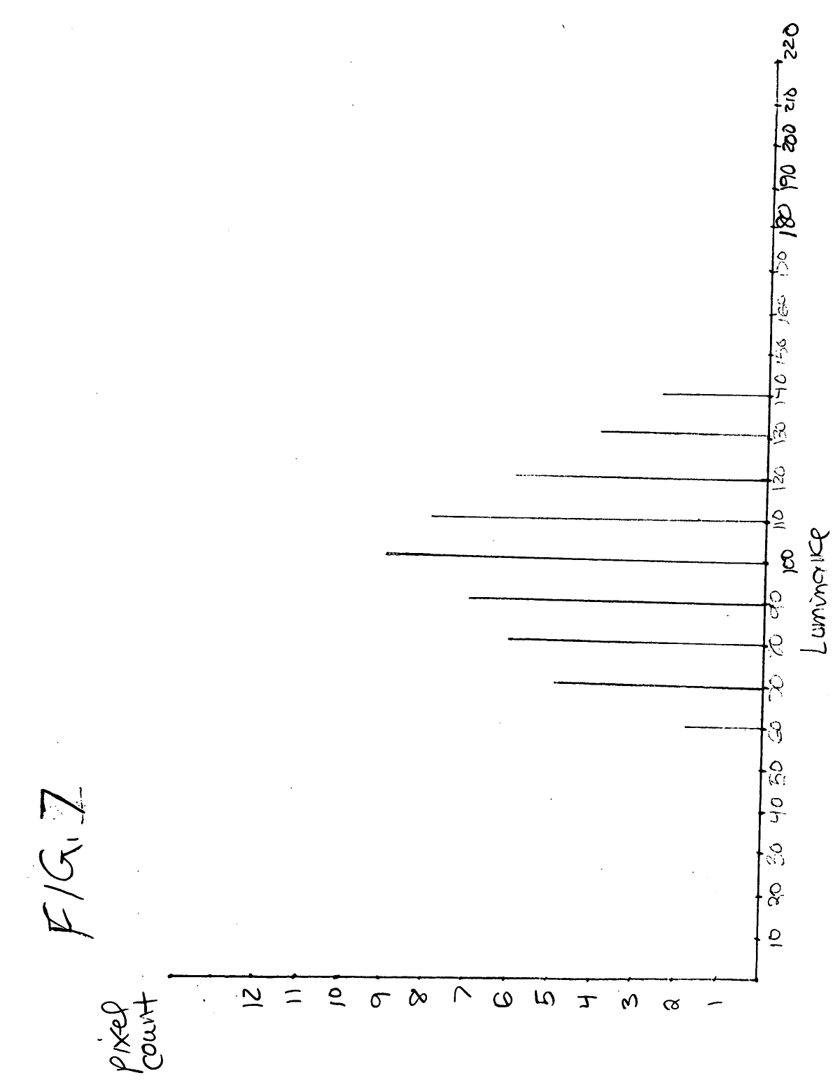

FIG. 6 illustrates a first transformed image 610, including two areas 612a, 612b that are each marked by an oblong shaped perimeter, a partial first transformed image 630a and a magnified second transformed image 630b. The magnified second transformed image 630b is a magnification of the partial first transformed image 630a and is superimposed upon the first transformed image 610. The first transformed image 610 is transformed from the first original image 410 of FIG. 4 via the combination of a luminance expansion function and a luminance inversion function.

As shown, the first transformed image 610 provides an image with enhanced contrast and clarity as compared that provided by the first original image 410 of FIG. 4. For example, the first transformed image 610 provides more clearly visible oblong shaped perimeters defining the areas 612a, 612b as compared to the oblong shaped perimeters defining the areas 412a, 412b of the first original image 410 of FIG. 4. The combination of luminance expansion and inversion in some cases makes details more visible than does luminance expansion alone.

Image luminance along the outside of the right side of the perimeter is substantially light while along the inside of the right side of the perimeter is substantially dark. Image luminance along the outside of the left side of the perimeter is a mixture of dark and light spots while along the inside of the left side of the perimeter is substantially light.

As described in association with FIG. 3, a luminance inversion function maps (modifies) the original luminance value of individual pixels to a transformed luminance value in order to invert the illumination of each pixel. The transformed luminance value is equal to the maximum luminance value (200) minus the original luminance value.

FIG. 7 illustrates a first distribution of luminance values for 50 pixels of an image. The distribution ranges between a minimum luminance value of 60 and a maximum luminance value of 140. This is an original distribution that is used to demonstrate the transformation functions described in FIGS. 8A-8D.

FIG. 8A illustrates a second distribution of pixel luminance values that is transformed from the first distribution of pixel luminance values of FIG. 7 via a luminance uniform expansion function. As shown, groups of pixels have luminance values of either 20, 40, 60, 80, 100, 120, 140, 160 or 180 units. The difference in luminance between pixels having different original luminance values remains uniform and is at least 20 units or alternatively a multiple of 20 units. As shown, the luminance expansion function increases the difference in the amount of luminance between a pair of pixels having unequal luminance values relative to the original difference in the amount of luminance between the same pair of pixels. Because only discrete luminance values are possible, expansion by a non-integer factor may lead to less consistent spacing between transformed luminance values, than shown in this example.

FIG. 8B illustrates a second distribution of pixel luminance values that is transformed from the first distribution of pixel luminance values of FIG. 7 via luminance non-uniform expansion function. As shown, groups of pixels have luminance values of either 30, 40, 50, 70, 100, 130, 150, 160 or 170 units. The difference in luminance between pixels having different original luminance values is not uniform and ranges from a minimum difference of 10 units to a maximum difference of 30 units.

As shown, the luminance non-uniform expansion function varies the difference in the amount of luminance between some pairs of pixels relative to the original difference between the same pairs of pixels. The luminance non-uniform expansion function increases the maximum difference of the luminance among pairs of pixels having originally different original luminance values.

FIG. 8C illustrates a second distribution of pixel luminance values that is transformed from the first distribution of pixel luminance values of FIG. 7 via a luminance consolidation and flattening function.

As shown, groups of pixels have luminance values of 70, 80, 90, 100, 110, 120, or 130 units. The difference in luminance between pixels having adjacent and different original luminance values is uniform and is equal to 10 units. The difference in luminance between pixels having different original luminance values is at least 10 units or alternatively a multiple of 10 units. Note that a luminance consolidation function can map different original luminance values to one transformed luminance value.

As shown, 7 pixels have a luminance of 70 units, 6 pixels have a luminance of 80 units, 7 pixels have a luminance of 90 units, 9 pixels have a luminance of 100 units, 8 pixels have a luminance of 110 units, 6 pixels have a luminance of 120 units, and 7 pixels have a luminance of 130 units.

The luminance consolidation and flattening function consolidates some of the pixels of FIG. 7 having different original luminance values into one luminance value. In this embodiment, luminance categories of 3 pixels or less are mapped to adjacent luminance categories in the direction towards the center of the distribution. The effect of this type of consolidation is to flatten the “normal like” distribution of FIG. 7.

The 2 pixels having a luminance value of 60 and 5 pixels having a luminance value of 70 as shown in FIG. 7 are mapped (consolidated into) to 7 pixels having a luminance value of 70 as shown in FIG. 8C. Likewise, the 3 pixels having a luminance value of 140 and 4 pixels having a luminance value of 130 as shown in FIG. 7 are mapped (consolidated into) to 7 pixels having a luminance value of 130 as shown in FIG. 8C.

FIG. 8D illustrates a second distribution of pixel luminance values that is transformed from the first distribution of pixel luminance values of FIG. 7 via the luminance consolidation and flattening function of FIG. 8C and further, a luminance uniform expansion function applied in FIG. 8D.

As shown, groups of pixels have luminance values of either 10, 40, 70, 100, 130, 160 or 190 units. The difference in luminance between pixels having adjacent and different original luminance values remains uniform but is expanded to equal to 30 units. The difference in luminance between pixels having different original luminance values is expanded but remains uniform and is at least 30 units or alternatively a multiple of 30 units.

As shown, the luminance uniform expansion function increases the difference in the amount of luminance between a pair of pixels relative to the original difference in the amount of luminance between the same pair of pixels.

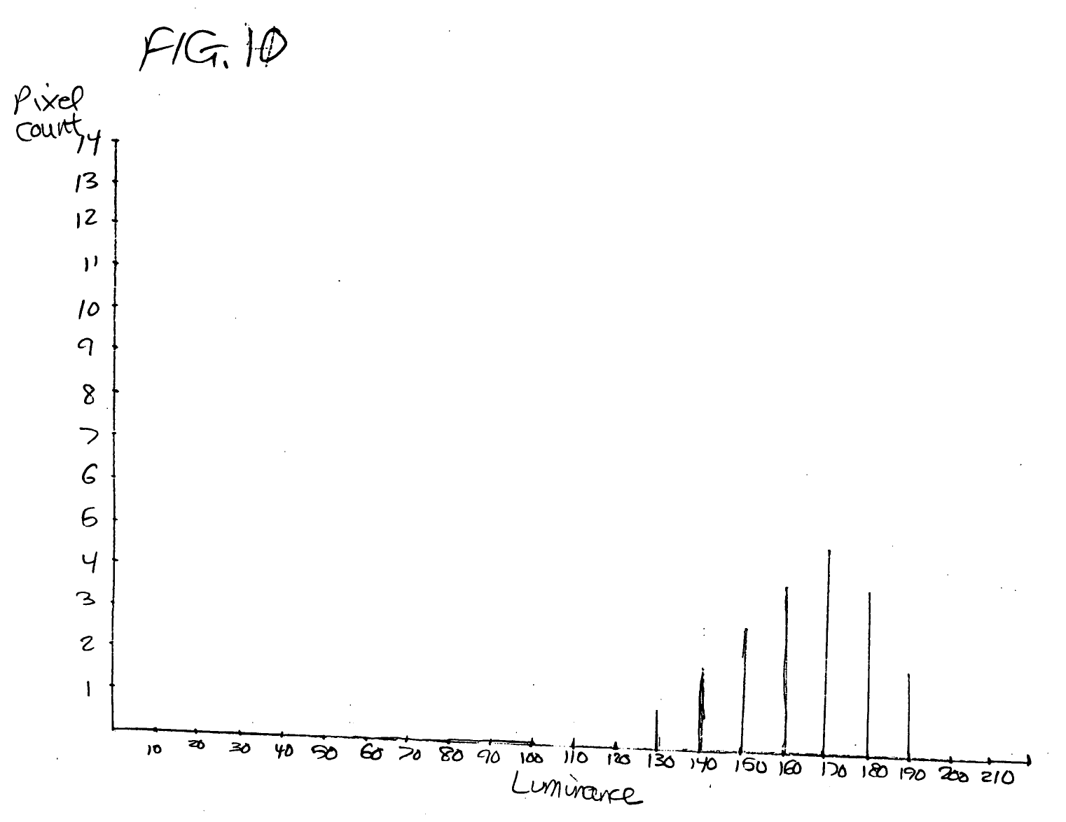

FIG. 9 illustrates a third distribution of pixel luminance values of an image that range between a minimum luminance value of 10 and a maximum luminance value of 70 and that range between a minimum pixel count of 1 and a maximum pixel count of 5.

As shown, 2 pixels have a luminance of 10 units, 4 pixels have a luminance of 20 units, 5 pixels have a luminance of 30 units, 4 pixels have a luminance of 40 units, 3 pixels have a luminance of 50 units, 2 pixels have a luminance of 60 units and 1 pixel has a luminance of 70 units.

As shown, groups of pixels have luminance values of 10, 20, 30, 40, 50, 60 or 70 units. The difference in luminance between pixels having adjacent and different original luminance values is uniform and equal to 10 units. The difference in luminance between pixels having different original luminance values is at least 10 units or alternatively a multiple of 10 units.

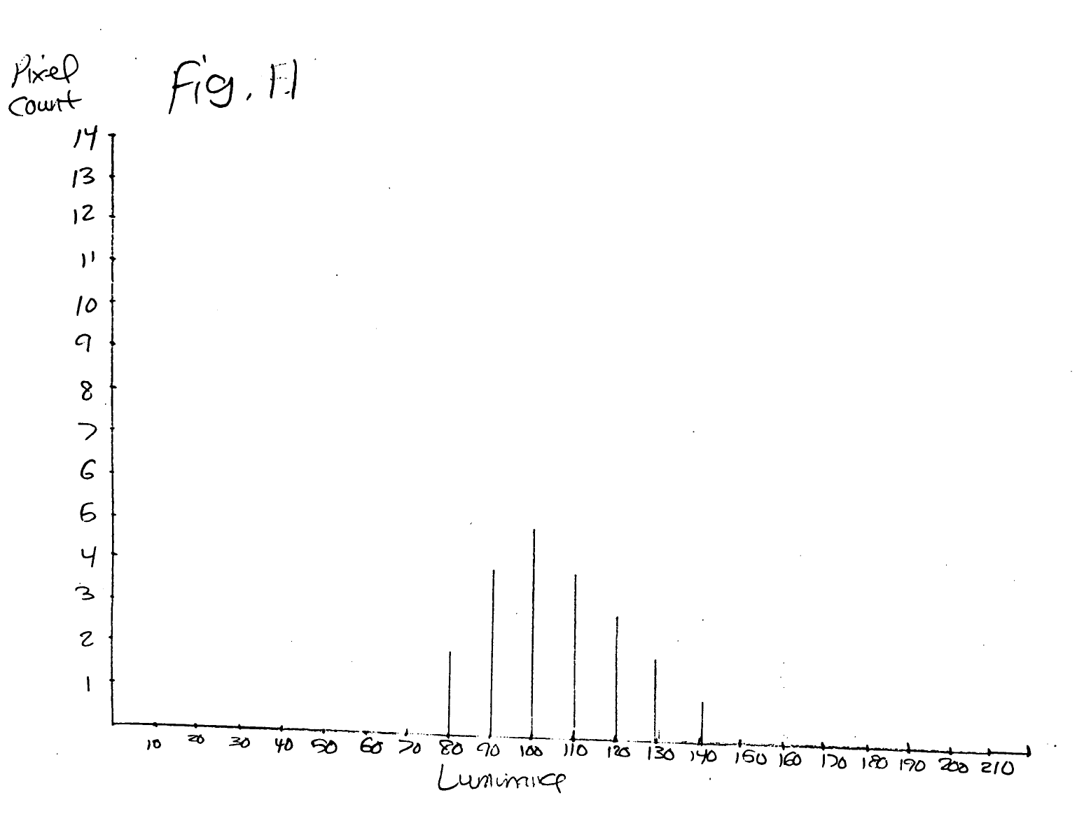

FIG. 10 illustrates a fourth distribution of pixel luminance values that is transformed from the third distribution of pixel luminance values of FIG. 9 via a luminance inversion function. The luminance inversion function effectively reverses the order of pixel counts and luminance of FIG. 9 from left to right. The pixel count of pixels of FIG. 9 having the least luminance are shown in FIG. 10 as having the most luminance. The pixel count of pixels of FIG. 9 having the most luminance are shown in FIG. 10 as having the least luminance.

As shown, groups of pixels have luminance values of 130, 140, 150, 160, 170, 180, or 190 units. The difference in luminance between pixels having adjacent and different original luminance values is uniform and is equal to 10 units. The difference in luminance between pixels having different original luminance values is at least 10 units or alternatively a multiple of 10 units.

As shown, 1 pixel has a luminance of 130 units, 2 pixels have a luminance of 140 units, 3 pixels have a luminance of 150 units, 4 pixels have a luminance of 180 units and 2 pixels have a luminance of 190 units. The luminance inversion function inverts the luminance of the pixels of FIG. 9. The transformed luminance value for each pixel is the maximum luminance value (200 units) minus the original luminance value for each pixel.

The 2 pixels that have a luminance of 10 units are mapped to have a luminance value of 190 units (200 units−10 units) in FIG. 10. The 4 pixels that have a luminance value of 20 units of FIG. 9 are mapped to have a luminance value of 180 in FIG. 10. The 5 pixels that have a luminance value of 30 units in FIG. 9 are mapped to have a luminance value of 170 units in FIG. 10. The 4 pixels that have a luminance of 40 units in FIG. 9 are mapped to have a luminance value of 160 units in FIG. 10. The 3 pixels that have a luminance of 50 units in FIG. 9 are mapped to have a luminance value of 150 in FIG. 10. The 2 pixels that have a luminance of 60 units in FIG. 9 are mapped to have a luminance value of 140 units in FIG. 10. The 1 pixel that has a luminance value of 70 units in FIG. 9 is mapped to have a luminance value of 130 units in FIG. 10.

FIG. 11 illustrates a fifth distribution of pixel luminance values which is transformed from the distribution of pixel luminance values of FIG. 9 via a luminance shifting function. In this embodiment, the transformed luminance value for each pixel is the original luminance value plus 70 units. The fifth distribution of pixel luminance values range between a minimum luminance value of 80 and a maximum luminance value of 140 and range between a minimum pixel count of 1 and a maximum pixel count of 5.

As shown, 2 pixels have a luminance of 80 units, 4 pixels have a luminance of 90 units, 5 pixels have a luminance of 100 units, 4 pixels have a luminance of 110 units, 3 pixels have a luminance of 120 units, 2 pixels have a luminance of 130 units and 1 pixel has a luminance of 140 units.

As shown, groups of pixels have luminance values of 80, 90, 100, 110, 120, 130 or 140 units. The difference in luminance between pixels having adjacent and different original luminance values remains uniform and equal to 10 units. The difference in luminance between pixels having different original luminance values is at least 10 units or alternatively a multiple of 10 units.

FIG. 12 illustrates a sixth distribution of pixel luminance values which is transformed from the fifth distribution of pixel luminance values of FIG. 11 via a luminance separating and shifting function. In this embodiment, pixels having a luminance value of 80 or 90 units are separated from the remainder of the distribution of FIG. 9 and shifted to having a luminance value of 30 and 40 units respectively, within the distribution of FIG. 11.

Likewise, pixels having a luminance value of 110, 120, 130 and 140 units are separated from the remainder of the distribution of FIG. 9 and shifted to having a luminance value of 160, 170, 180 and 190 units respectively, within the distribution of FIG. 11. Pixels having a luminance value of 100 within the distribution of FIG. 9 are not shifted and remain having a luminance value of 100 within the distribution of FIG. 11.

In this embodiment, groups of pixels having pixels counts with luminance lower and higher than the group of pixels having the highest pixel count are separated and shifted as separate portions of the distribution. Pixels with lower luminance are shifted lower by subtracting 50 units from the original luminance value (90 or 90 units). Pixels with higher luminance are shifted higher by adding 50 units from the original luminance value (110, 120, 130 or 140 units).

As shown, different groups of pixels have luminance values of 30, 40, 100, 160, 170, 180 or 190 units. The maximum difference in luminance between pixels having adjacent and different original luminance values is 50 units. The maximum difference in luminance between pixels having different original luminance values remains at least 10 units or alternatively a multiple of 10 units. As shown, 2 pixels have a luminance of 30 units, 4 pixels have a luminance of 40 units, 5 pixels have a luminance of 100 units, 4 pixels have a luminance of 160 units, 3 pixels have a luminance of 170 units, 2 pixels have a luminance of 180 units and 1 pixel has a luminance of 190 units.

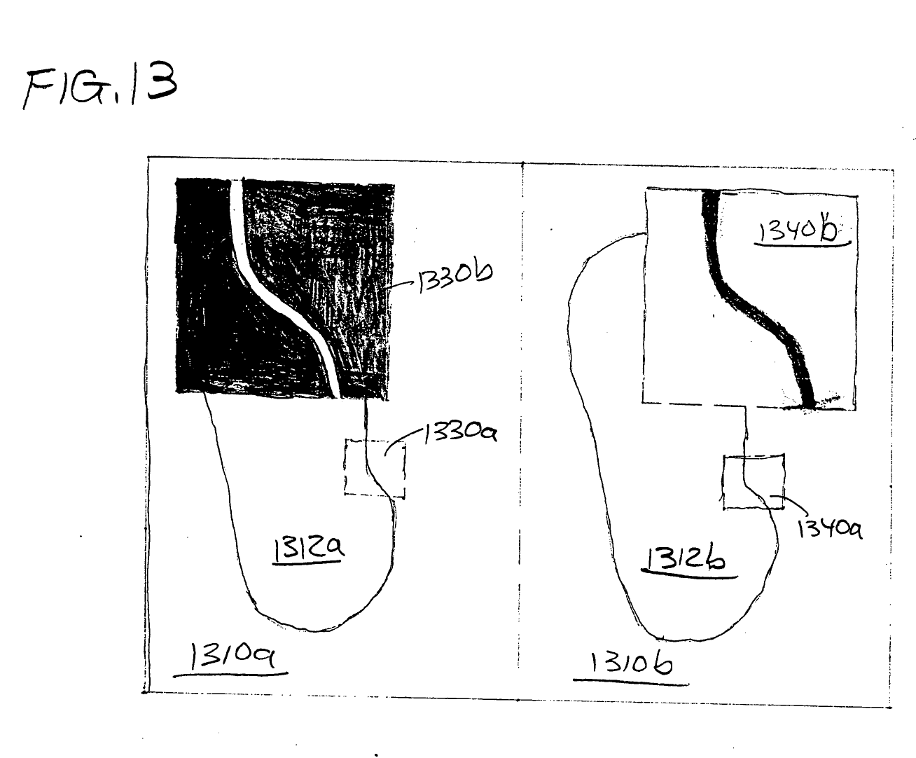

FIG. 13 illustrates two portions 1310a, 1310b of a first stereo image. Each portion 1310a, 1310b respectively includes a marked area 1312a, 1312b with an oblong shaped perimeter. Each portion 1310a, 1310b also respectively includes a partial image 1330a, 1340a. Each partial image 1330a, 1340a respectively includes a portion of the marked area 1312a, 1312b and respectively includes a superimposed magnified image 1330b and 1340b that is each a magnification of the partial image 1330a and 1340a respectively.

Illustrative embodiments of a stereo measure remote viewing device are described in U.S. non-provisional patent application Ser. No. 10/056,868, titled “Stereo Measurement Boroscope”, filed Jan. 25, 2002 and which is hereby incorporated by reference in its entirety.

Illustrative embodiments of automatic defect detection using a remote viewing device are described in U.S. non-provisional patent application Ser. No. 10/393,341, titled “Automatic Defect Detection for an Endoscope”, filed Mar. 20, 2003 and which is hereby incorporated by reference in its entirety

Unlike FIG. 2 and FIG. 3, the superimposed magnified images 1330b, 1340b are not superimposed over their respective partial images 1330a and 1340a. As shown, the superimposed magnified image 1330b is magnified and transformed via a luminance inversion function.

In other embodiments, the superimposed magnified images 1330b, 1340b can be transformed in various ways and/or magnified from the first and second partial images 1330a and 1340a respectively. Optionally, the superimposed magnified images 1330b, 1340b can be transformed via a same or different transformation function. It is also possible to increase the number of magnified images to any desired number.

We claim:

1. A method for enhancing the clarity of at least a portion of an image captured by a remote viewing device, comprising the steps of:
capturing a first original image via a remote viewing device, said first original image represented by a first plurality of pixels, each of said first plurality of pixels having a original luminance component;
selecting at least a second plurality of pixels, said second plurality of pixels constituting a second original image and including at least a subset of said first plurality of pixels of said first original image;
quantifying each said original luminance component as a original luminance value for each of said second plurality of pixels to collectively form a second plurality of original luminance values that are represented within a second original distribution of said original luminance values, said second original distribution of said original luminance values representing a second original image;
transforming said second original distribution by mapping each said original luminance value represented within said second original distribution of luminance values to an associated transformed luminance value represented within a second transformed distribution of luminance values;
constructing a second transformed image from said second transformed distribution of luminance values;
displaying said second transformed image.

2. The method of claim 1, where said second transformed distribution is transformed from said second original distribution via a luminance inversion function.

3. The method of claim 1, where said second transformed distribution is transformed from said second original distribution via a luminance expansion function.

4. The method of claim 1, where said second transformed distribution is transformed from said second original distribution via a luminance shifting function.

5. The method of claim 1, where said second transformed distribution is transformed from said second original distribution via a luminance dividing and shifting function that divides said second original distribution into multiple portions that include at least a first and a second portion.

6. The method of claim 5, where said first and/or said second portions of said second original distribution are each shifted in a direction towards the other said portion.

7. The method of claim 5, where said first and/or said second portions of said second original distribution are each shifted in a direction away from the other said portion.

8. The method of claim 1, where at least a portion of said first original image and at least a portion of said second transformed image are displayed simultaneously.

9. The method of claim 1, where said second transformed image is magnified with respect to said second original image.

10. The method of claim 1, where said quantifying, mapping and displaying steps are performed on the entirety of said first original image to generate a first transformed image.

11. The method of claim 10, where said first transformed image and second transformed image are displayed simultaneously.

12. The method of claim 11, where separate and different mapping steps are performed to generate said first transformed image and said second transformed image and where at least a portion of both said first transformed image and said second transformed image are displayed simultaneously.

13. The method of claim 11, where the same mapping steps are performed to generate said first transformed image and said second transformed image and where at least a portion of both said first transformed image and said second transformed image are displayed simultaneously.

14. The method of claim 1, where said second original image and said second transformed image each include all of said plurality of pixels constituting said first original image.

15. The method of claim 2, where said second original image is represented by an RGB color space model that is translated into a different color space model prior to said transforming step.

16. The method of claim 3, where said second original image is represented by an RGB color space model that is translated into a different color space model prior to said transforming step.

17. The method of claim 4, where said second original image is represented by an RGB color space model that is translated into a different color space model prior to said transforming step.

18. The method of claim 2 where said transforming step is performed using a quasi-luminance transformation function.

19. The method of claim 3 where said transforming step is performed using a quasi-luminance transformation function.

20. The method of claim 4 where said transforming step is performed using a quasi-luminance transformation function.

21. An apparatus for enhancing the clarity of at least a portion of an image captured by a remote viewing device, comprising:
a luminance isolator that is configured for
processing a first original image captured by a remote viewing device, said first original image represented by a plurality of pixels and where each of said plurality of pixels has an original luminance component; and configured for
selecting a second plurality of pixels, said second plurality of pixels constituting a second original image and including at least a subset of said plurality of pixels of said first original image; and configured for
quantifying each said original luminance component as an original luminance value for each of said second plurality of pixels to collectively form a second plurality of original luminance values that are represented within a second original distribution of said original luminance values, said second original distribution of said original luminance values representing a second original image; and
a luminance transformer that is configured for mapping each said original luminance value represented within said second original distribution of luminance values to an associated transformed luminance value represented within a second transformed distribution of luminance values, said second transformed distribution of luminance values representing a second transformed image.

22. The apparatus of claim 21, where said second transformed distribution is transformed from said second original distribution via a luminance inversion function.

23. The apparatus of claim 21, where said second transformed distribution is transformed from said second original distribution via a luminance expansion function.

24. The apparatus of claim 21, where said second transformed distribution is transformed from said second original distribution via a luminance shifting function.

25. A method for enhancing the clarity of at least a portion of a captured image, comprising the steps of:
capturing a first original image, said first original image represented by a plurality of pixels, each of said plurality of pixels having an original luminance component;
selecting at least a second plurality of pixels, said second plurality of pixels including at least a subset of said first plurality of pixels of said first original image and constituting a second original image;
quantifying each said original luminance component as a original luminance value for each of said second plurality of pixels to collectively form a second plurality of original luminance values that are represented within a second original distribution of said original luminance values, said second original distribution of said original luminance values representing a second original image;
transforming said second original distribution by mapping each said original luminance value represented within said second original distribution of luminance values to an associated transformed luminance value represented within a second transformed distribution of luminance values;
constructing a second transformed image from said second transformed distribution of luminance values;
magnifying said second transformed image; and
displaying said second transformed image in accordance with said second transformed distribution of luminance values.

26. A remote viewing device, comprising:
an insertion tube;
a viewing head assembly disposed at a distal end of said insertion tube that is configured for capturing an image;
a luminance isolator that is configured for processing a first original image captured by said viewing head, said first original image represented by a plurality of pixels and where each of said plurality of pixels has an original luminance component; and selecting a second plurality of pixels, said second plurality of pixels constituting a second original image and including at least a subset of said plurality of pixels of said first original image; and quantifying each said original luminance component as a original luminance value for each of said second plurality of pixels, to collectively form a second plurality of original luminance values that are represented within a second original distribution of said original luminance values; and
a luminance transformer that is configured for mapping each said original luminance value represented within said second original distribution of luminance values to an associated transformed luminance value represented within a second transformed distribution of luminance values, said second transformed distribution of luminance values representing a second transformed image.
